(19) United States
(12) Patent Application Publication
(10) Pub. No.: US 2012/0139221 A1
(43) Pub. Date: Jun. 7, 2012

(54) Power Stand Assembly for Motorcycles

(76) Inventor: CHIU-HSIANG LO, Taichung County (TW)

(21) Appl. No.: 12/957,615

(22) Filed: Dec. 1, 2010

(51) Int. Cl. B60S 9/04

(52) U.S. Cl. 280/766.1

(57) ABSTRACT

A stand assembly for motorcycles includes a stand unit, a motor, a power transmission mechanism and a switch set. The stand unit includes a first part pivotably connected to the bottom of the frame and a second part is retractably connected to the first part. The power transmission mechanism controls the motor to extend the second part relative to the first part to support the frame of the motorcycle or power bicycle. When the motorcycle or the power bicycle is ridden, the power transmission mechanism controls the motor to retract the second part relative to the first part.

### FIELD OF THE INVENTION

The present invention relates to a stand assembly, and more particularly, to a power stand assembly for motorcycles.

### BACKGROUND OF THE INVENTION

A conventional stand is connected to the bottom of the motorcycles or power bicycles, and when the stand is in its activated position, the motorcycle or power bicycle is lifted and supported.

The conventional stand can be manually or electrically operated, the manual stand has to be operated by both hands and feet, and significant muscle power is required so that some of the users feel difficult to operate the stand.

The conventional electrical stand is operated by way of mechanical or hydraulic driving methods, and the stand is stretched to support the motorcycle or power bicycle. However, the mechanical or hydraulic driving mechanism is secured to the frame of the motorcycle or power bicycle, and cannot be pivoted accompanying with the stand. In other words, the mechanical or hydraulic driving mechanism is integrally connected to the stand so that once the mechanical or hydraulic driving mechanism is failed or broken down, the stand cannot be retracted from the activation or support status, and the motorcycle or power bicycle can't be driven normally because it is limited in support status with one wheel up into the air. In addition, the electric stand has to be operated by pressing a switch or button which may be touched unintentionally and this is dangerous when the motorcycle or power bicycle is driven on roads.

The present invention intends to provide an intelligent stand assembly which can be operated electrically and manually.

### SUMMARY OF THE INVENTION

The present invention relates to a stand assembly and includes a stand unit, a motor, a power transmission mechanism and a switch set. The stand unit includes a first part pivotably connected to the bottom of the frame and a second part is retractably connected to the first part. The stand unit is pivotably connected to the bottom of the frame and located between the two wheels of the motorcycle or the power bicycle. The power transmission mechanism controls the motor to extend the second part relative to the first part to support the frame of the motorcycle or power bicycle. When the motorcycle or the power bicycle is ridden, the power transmission mechanism controls the motor to retract the second part relative to the first part.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the stand assembly of the present invention;

FIG. 2 shows the stand assembly of the present invention connected to the frame and a cover is to be connected to the stand assembly;

FIG. 3 is viewed from the bottom of the frame to show the stand assembly of the present invention connected to the frame;

FIG. 4 is a partial enlarged view of the stand assembly of the present invention ion FIG. 3;

FIG. 5 is a perspective view to show that the second part is retracted relative to the first part of the stand assembly of the present invention;

FIG. 6 is a side view to show that the second part is retracted relative to the first part of the stand assembly of the present invention;

FIG. 7 is a perspective view to show that the second part is extended relative to the first part of the stand assembly of the present invention;

FIG. 8 is a side view to show that the second part is extended relative to the first part of the stand assembly of the present invention;

FIG. 9 shows that the stand unit of the present invention is connected to a motorcycle and is in the retrieved position;

FIG. 10 shows that the stand unit of the present invention is connected to a motorcycle and is in the support position; and

FIG. 11 shows the control module of the stand unit of the present invention.

### DETAILED DESCRIPTION OF THE PREFERRED EMBODIMENT

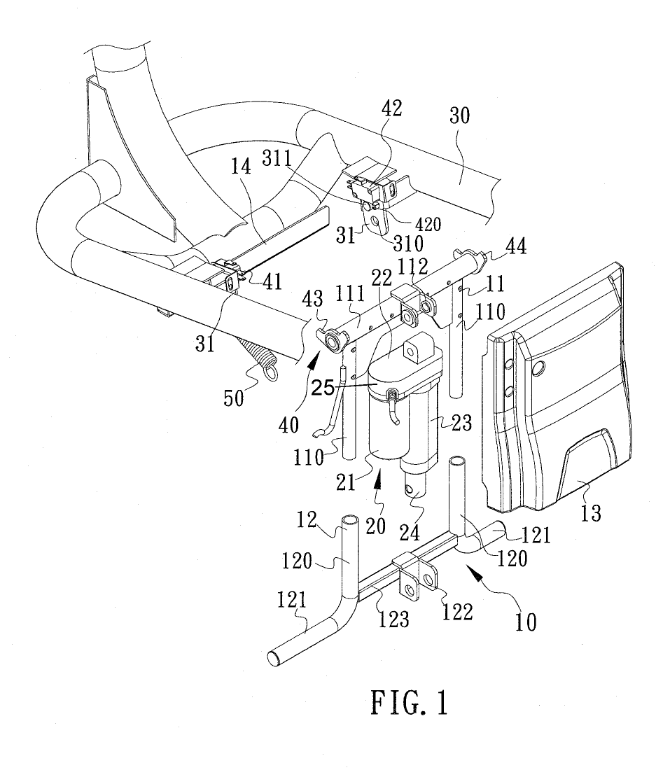

Referring to FIGS. 1, 9 and 10, the stand assembly of the present invention is used to support a motorcycle or a power bicycle and the power unit 20 is connected to the stand unit 10 so that the power unit 20 together with the stand unit 10 are pivotable to a desired position and the stand unit 10 is controlled to extend or retract. The pivotable movement of the stand unit 10 is not limited by the position of the power unit 20. When the power unit 20 is failed, the stand unit 10 still can be functioned. Moreover, there is a detection assembly for detect the support and the retrieved position without the requirement of manual operation to activate the power unit 20 so as to avoid from unintentional touch by the user to ensure the safety of operation.

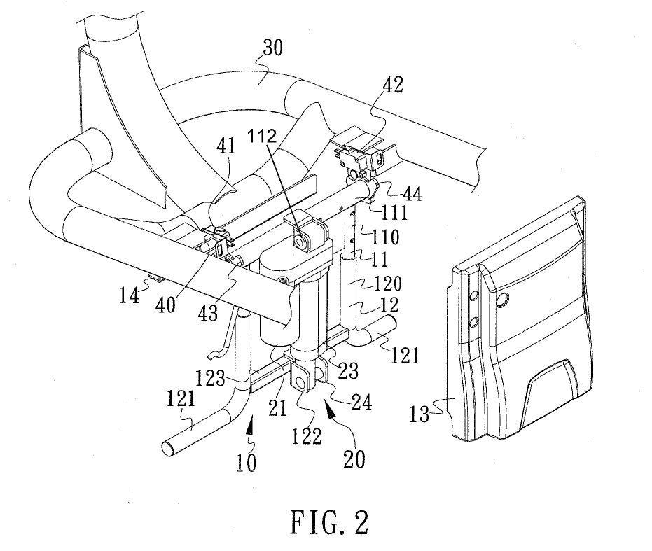

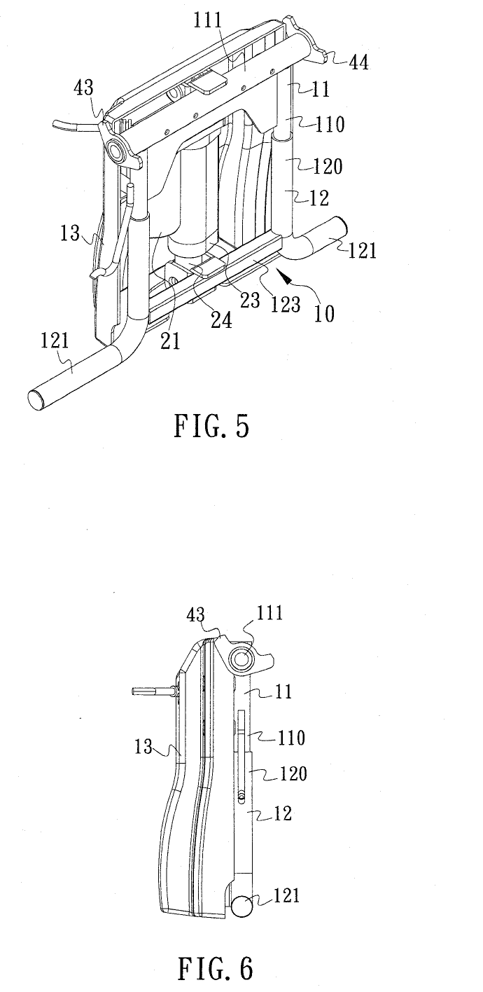

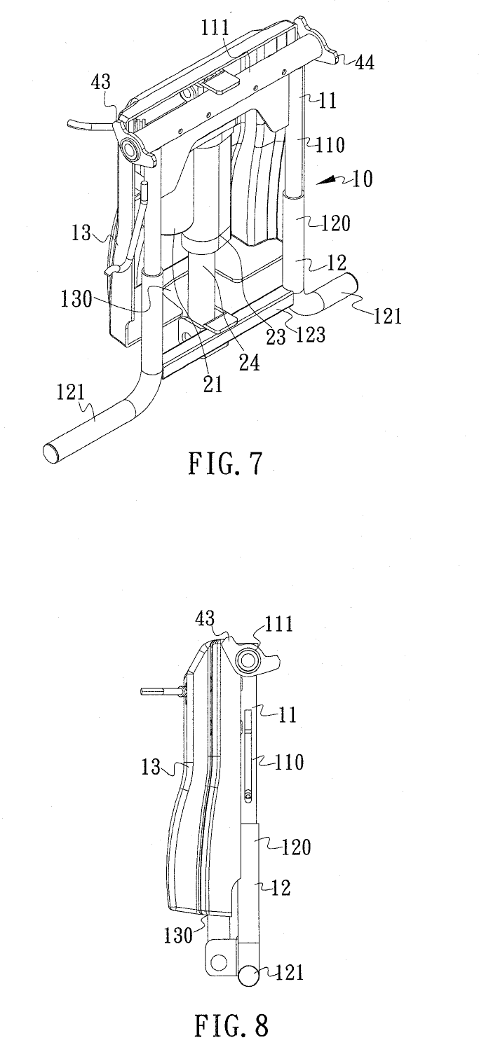

Referring to FIGS. 1 and 2, the stand assembly comprises a stand unit 10 and a power unit 20, wherein the power unit 20 includes a motor 21 and a power transmission mechanism 22. The stand unit 10 includes a first part 11 and a second part 12. The first part 11 is pivotally connected to the bottom of the frame 30 of the motorcycle or the power bicycle and located between two wheels 32 connected to the frame 30. The power transmission mechanism 22 controls the motor 21 to extend or retract the second part 12 relative to the first part 11. The motor 21 and the power transmission mechanism 22 are connected to and mounted on the stand unit 10 which is pivotable relative to the frame 30. When the second part 12 is extended relative to the first part 11, the frame 30 is partially lifted relative to the ground and one of the wheels 32 is lifted in the air. The motor 21 and the power transmission mechanism 22 are connected to and mounted on the stand unit 10 and can be pivotable relative to the frame 30. When a switch module 40 detects the stand unit 10 to pivot relative to the frame 30 to a support position, the motor 21 is activated to extend the second part 12 relative to the first part 11 as shown in FIGS. 7 and 8. And when the switch module 40 detects the stand unit 10 to pivot relative to the frame 30 toward a retrieved position, the motor 21 is activated to retract the second part 12 relative to the first part 11 as shown in FIGS. 5 and 6.

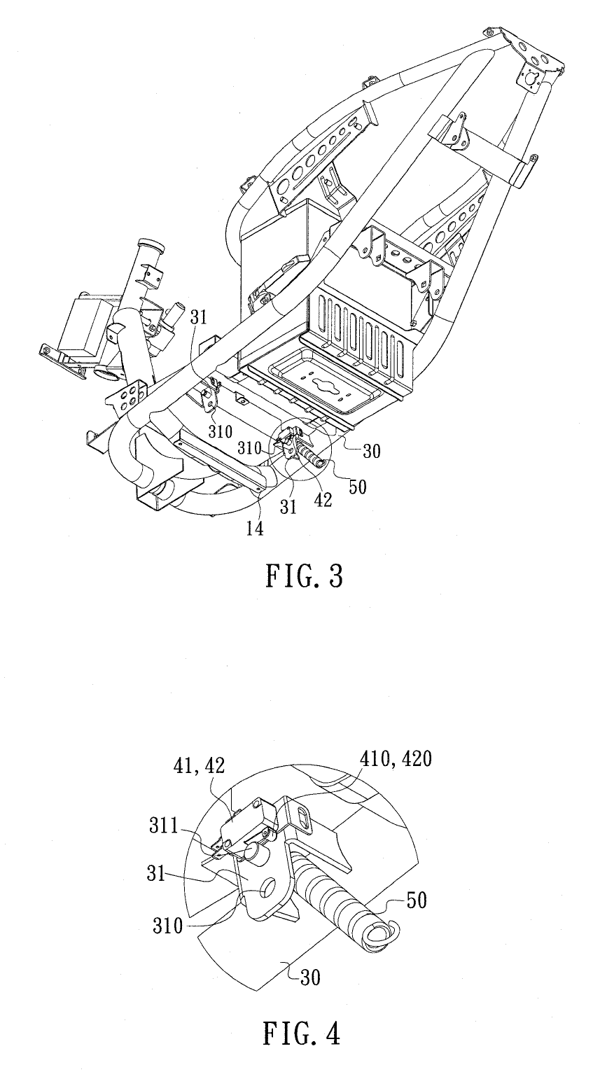

Referring to FIGS. 1, 2, 7 and 8, the stand unit 10 provides a space for receiving the motor 21, the power transmission mechanism 22, the first part 11 and the second part 12. The stand unit 10 includes a cover 13 which has a recessed inside and a notch 130 is defined in a periphery thereof, the retractable rod 24 extends through the notch 130. The frame 30 includes a stop 14 (in the embodiment, the stop 14 is a transversal bar) and the stand unit 10 is stopped by the stop 14 when the stand unit 10 is in the support position. A spring 50 is connected between the stand unit 10 and the frame 30 as shown in FIGS. 3 and 4, the spring 50 provides a force to assist the stand unit 10 to pivot toward the frame 30 for retrieve.

The power unit 20 includes the motor 21, the power transmission mechanism 22, a cylinder 23 and a base 25 pivotally connected to the first part 11. The base 25 is provided for equipping the motor 21 and the cylinder 23, and for receiving the power transmission mechanism 22. A retractable rod 24 is retractably inserted into the cylinder 23 and driven by the power 21 to linearly move relative to the cylinder 23. The cylinder 23 is connected to the first part 11 via the base 25 and the retractable rod 24 is connected to the second part 12. The power unit 20 can be an electric cylinder for driving linearly and which is well known and not described here.

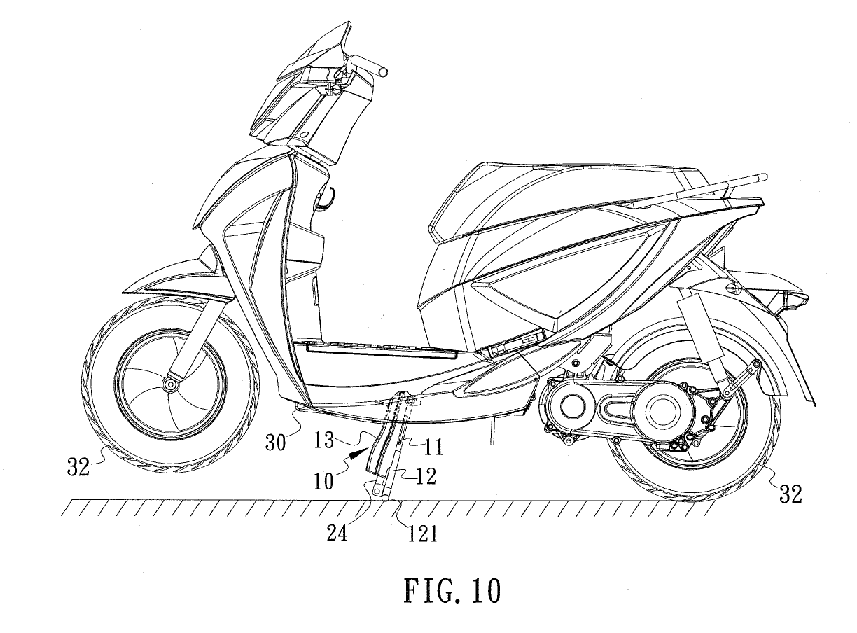

As shown in FIGS. 1, 5 and 7, the first part 11 includes a first transverse bar 111 to which two first tubes 110 are vertically connected. Two first lugs 112 are connected to the first transverse bar 111. The second part 12 includes a second transverse bar 123 to which two second tubes 120 are vertically connected, and two second lugs 122 are connected to the second transverse bar 123. The first tubes 110 are retractably inserted into the second tubes 120. The cylinder 23 is pivotably connected to the first lugs 112 via the base 25 and the distal end of the retractable rod 24 is pivotably connected to the second lugs 122. The two second tubes 120 each have a bent section 121 which is bent 90 degrees so as to increase the area for contacting the ground when support the motorcycle as shown in FIG. 10.

As shown in FIGS. 1 and 4, the switch module 40 includes a first switch 41, a second switch 42, a first push member 43 and a second push member 44. The first and second push members 43, 44 are located on two ends of the first transverse bar 111, and the first and second switches 41, 42 are respectively connected to the lugs 31 on two sides of the frame 30. The two ends of the first transverse bar 111 extend to pivotally and coaxially connect with the two respective holes 310 of the two lugs 31 respectively so that the first part 11 is pivotable about the axis of the first transverse bar 111 and pivotable relative to the frame 30. The first and second switches 41/42 and the first and second push members 43/44 are connected to the frame 30 and the stand unit 10 respectively and located close to the pivotal connection between the stand unit 10 and the frame 30. The first push member 43 touches the first switch 41 when the stand unit 10 is in the support position. The motor 21 is activated to extend the second part 12 relative to the first part 11. The second push member 44 touches the second switch 42 when the stand unit 10 is in the retrieved position. The motor 21 is activated to retract the second part 12 relative to the first part 11. As shown in FIGS. 5 and 6, the lugs 31 each have a protrusion 311 to limit the rotation angle of the first/second touch member 43/44.

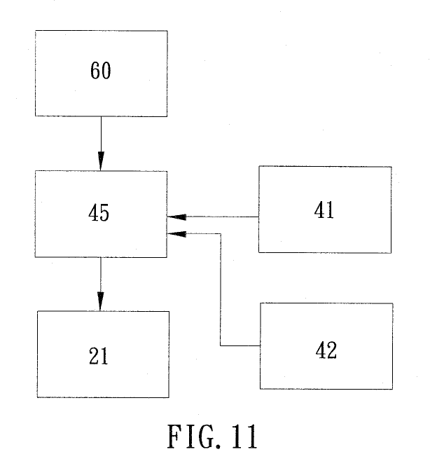

As shown in FIGS. 4, 11, the first and second switches 41, 42 can be limit switches or magnetic-spring switches which have an activation piece 410/420 which can be pressed to activate the switches 41, 42. A control module 45 is electrically connected between the motor 21, the first switch 41 and the second switch 42. In one embodiment, the control module 45 is composed of driving IC, transistors, and relays so as to provide positive voltage or negative voltage to the motor 21, wherein the positive voltage or negative voltage is provided by a power supply unit 60. The control module 45 is well known and will not be described in detail.

Referring to FIGS. 1, 2 and 10, when the user wants to stand the motorcycle, the user simply clockwise pivots the stand unit 10 about the lugs 31 to an angle exceeding the plumb line. Before the power unit 20 touching the stop 14 and being limited, the first push member 43 touches the activation piece 410 of the first switch 41, the motor 21 is activated in the positive direction and the power of motor 21 is transferred by the power transmission mechanism 22 to the retractable rod 24, the retractable rod 24 linearly extends with respect to the cylinder 23 and pushes the second part 12 to extend from the first part 11 until the frame 30 is partially lifted up and one wheel 32 is located in the air to stand the motorcycle (referring to FIGS. 7, 8 and 10).

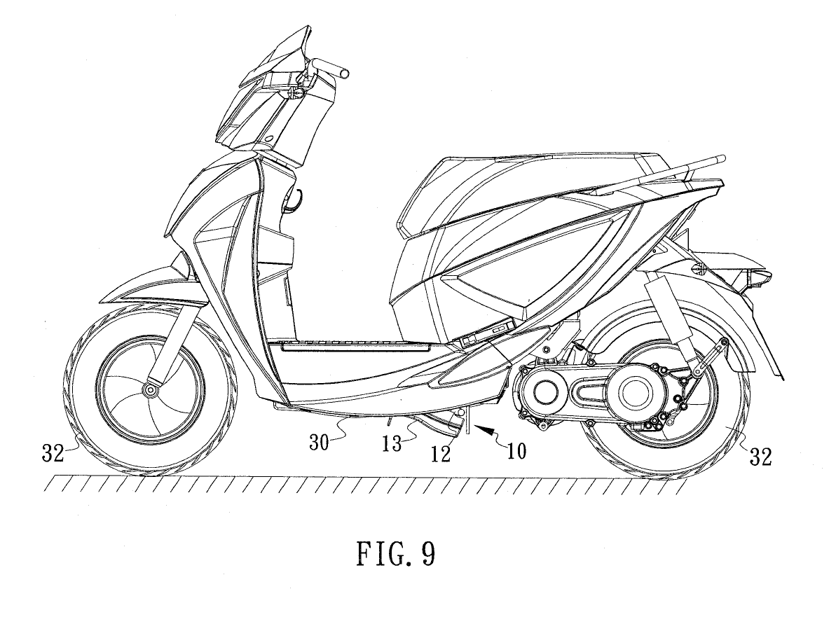

Referring to FIGS. 1, 2 and 9, when the user wants to retrieve the stand unit 10, the user simply pushes the motorcycle forward, the distal end of the stand unit 10 is pushed back by the reacting force from the ground, and then the stand unit 10 counterclockwise rotates with respect to the frame 30. When the stand unit 10 counterclockwise rotates exceeding the plumb line, the frame 30 is then lowered and the two wheels 32 touch the ground as shown in FIG. 9. Meanwhile the stand unit 10 is pulled by the spring force from the spring 50, and is pivoted and retrieved toward the frame 30. After the stand unit 10 counterclockwise rotating exceeding the plumb line, the second push member 44 touches the activation piece 420 of the second switch 42, the motor 21 is activated in the negative direction and the power of the motor 21 is transferred by the power transmission mechanism 22 to the retractable rod 24, the retractable rod 24 linearly retracts with respect to the cylinder 23 and pulls the second part 12 to retract toward the first part 11 as shown in FIGS. 5 and 6.

When the motor 21 fails, the stand unit 10 can be pivoted relative to the frame 30 such that the two wheels 32 of the motorcycle touch the ground, even if the second part 12 cannot be retracted, the motorcycle still can be normally operated. With the cooperation of the switch module 40, the user can simply pivots the stand unit 10 without safety concern to control the movement of the second part 12.

While we have shown and described the embodiment in accordance with the present invention, it should be clear to those skilled in the art that further embodiments may be made without departing from the scope of the present invention.

What is claimed is:

1. A stand assembly comprising:
a stand unit having a first part and a second part, the first part being connected to a frame and located between two wheels connected to the frame;
a power unit having a motor and a power transmission mechanism which controls the motor to extend or retract the second part relative to the first part, the motor and the power transmission mechanism being mounted on the stand unit which is pivotable relative to the frame, and
a switch module detecting the stand unit to pivot relative to the frame to a support position, the motor being activated to extend the second part relative to the first part, the switch module detecting the stand unit to pivot relative to the frame to a retrieved position, the motor being activated to retract the second part relative to the first part.

2. The stand assembly as claimed in claim 1, wherein the stand unit includes a cover which is located beneath the stand unit when the stand unit is in the retrieved position.

3. The stand assembly as claimed in claim 1, wherein the frame includes a stop and the stand unit is stopped by the stop when the stand unit is in the support position.

4. The stand assembly as claimed in claim 1, wherein the motor, the power transmission mechanism and a cylinder are mounted on a base, a retractable rod is retractably inserted into the cylinder and driven by the power and moves relative to the cylinder, the base is connected to the first part and the retractable rod is connected to the second part.

5. The stand assembly as claimed in claim 4, wherein the stand unit includes a cover which has a recessed inside and a notch is defined in a periphery thereof, the retractable rod extends through the notch.

6. The stand assembly as claimed in claim 4, wherein the first part includes a first transverse bar to which two first tubes are connected, first lugs are connected to the first transverse bar, the second part includes a second transverse bar to which two second tubes are connected, second lugs are connected to the second transverse bar, the first tubes are retractably inserted into the second tubes, the base is pivotably connected to the first lugs and the retractable rod is pivotably connected to the second lugs.

7. The stand assembly as claimed in claim 1, wherein the first part includes a first transverse bar to which two first tubes are connected, the second part includes a second transverse bar to which two second tubes are connected, the first tubes are retractably inserted into the second tubes.

8. The stand assembly as claimed in claim 1, wherein the switch module includes a first switch, a second switch, a first push member and a second push member; the first push member touches the first switch when the stand unit is pivoted toward the support position, the motor is activated to extend the second part relative to the first part; the second push member touches the second switch when the stand unit is pivoted toward the retrieved position, the motor is activated to retract the second part relative to the first part.

9. The stand assembly as claimed in claim 1, wherein the switch module includes a first switch and a first push member, the first switch and the first push member are respectively connected to the frame and the stand unit, and are located close to a pivotal connection between the stand unit and the frame; the first push member touches the first switch when the stand unit is pivoted toward the support position, the motor is activated to extend the second part relative to the first part; the second push member touches the second switch when the stand unit is pivoted toward the retrieved position, the motor is activated to retract the second part relative to the first part.

10. The stand assembly as claimed in claim 1, wherein a spring is connected between the stand unit and the frame, the spring provides a force to assist the stand unit to pivot toward the frame.
